(19) United States
(12) Patent Application Publication
(10) Pub. No.: US 2024/0095492 A1
(43) Pub. Date: Mar. 21, 2024

(54) MEMORY MANAGEMENT FOR MATHEMATICAL OPERATIONS IN COMPUTING SYSTEMS WITH HETEROGENEOUS MEMORY ARCHITECTURES

(71) Applicant: QUALCOMM Incorporated, San Diego, CA (US)

(72) Inventors: Jian SHEN, San Diego, CA (US); Sameer WADHWA, San Diego, CA (US)

(21) Appl. No.: 17/934,178

(22) Filed: Sep. 21, 2022

(51) Int. Cl. G06N 3/02; G06N 20/00

(52) U.S. Cl. CPC G06N 3/02; G06N 20/00

(57) ABSTRACT

Certain aspects of the present disclosure provide techniques and apparatus for performing mathematical operations on a processor. The method generally includes initializing at least a portion of weight data for a machine learning model in a first memory component associated with a processor. Input data is stored in a second memory component coupled with the processor. Operations using the machine learning model are executed, via a functional unit associated with the processor, based on the at least the portion of the weight data and the input data. A result of the operations using the machine learning model are stored in the second memory component.

### INTRODUCTION

Aspects of the present disclosure relate to memory management during execution of mathematical operations on a computing device having a heterogeneous memory architecture.

The von Neumann architecture that many computing systems implement generally separates a processor and memory such that in order to perform operations, the processor reads data from and writes data to the memory via a bus. The memory of a von Neumann architecture computing system may be divided into different portions with differing performance characteristics and with differing distances from the processor. For example, memory may be organized in a hierarchy in which small, fast memory components may have higher performance and be located closer to the processor than larger, slower memory components. For example, a high-performance memory may be used as a cache to temporarily store data and may be located close to or may be co-located with a processor that performs various operations with respect to that data. An off-processor memory component may be used to temporarily store other data that is not currently being used by the processor but may have recently been used or may be expected to be used in the near future. This off-processor memory component may be larger than a cache, but may have longer latencies (e.g., longer read/write times) relative to a cache. Still other memory components may be included in a computing system, with longer distances from the processor and lesser performance characteristics, such as a solid state drive or hard disk drive in which data is persistently stored, network storage devices from which a processor may retrieve data for processing via a network connection, and the like.

Because of the cost of high-performance memory that may be used to store data close to a processor that performs operations on such data, computing systems may be designed to have a limited amount of high-performance memory and larger amounts of lower performance memory. In many cases, the amount of high-performance memory included in a computing system may be significantly smaller than the amount of memory needed to perform various mathematical operations, such as mathematical operations used to perform various machine learning tasks, on the computing device. Thus, in order to perform various mathematical operations on a computing device, the computing device may need to swap data between high-performance memory and lower performance memory, which may use power each time data is swapped. This power usage may be cumulative, and thus have a significant impact on energy consumption, heat generation (and corresponding cooling requirements), battery life, and other properties of the computing device.

Accordingly, what is needed are improved techniques for memory management in computing systems executing mathematical operations.

### BRIEF SUMMARY

Certain aspects provide a computer-implemented method for performing operations using a machine learning model on a processor. The method generally includes initializing at least a portion of weight data for a machine learning model in a first memory component associated with a processor. Input data is stored in a second memory component coupled with the processor. Operations using a machine learning model are executed, via a functional unit associated with the processor, based on the at least the portion of the weight data and the input data. A result of the operations using the machine learning model is stored in the second memory component.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods, as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIGS. 1A-1C illustrate example processors in which different data relevant for machine learning operations are stored in different types of memory associated with a processor, according to aspects of the present disclosure.

FIG. 2 is a flow chart illustrating operations for executing operations using a machine learning model based on weight data loaded in nonvolatile random access memory and other data in dynamic random access memory, according to aspects of the present disclosure.

FIG. 3 illustrates example operations for using a machine learning model with different data relevant for the operations being stored in different types of memory associated with a processor, according to aspects of the present disclosure.

FIG. 4 illustrates an example implementation of a processing system in which operations using a machine learning model can be performed with different data being stored in different types of memory, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide techniques for storing data used in performing operations using a machine learning model across different types of memory components associated with a processor.

Computing systems (such as those implementing the von Neumann architecture) generally organize memory by performance and proximity to a processor that performs operations using the memory. Generally, a small amount of high-performance memory may be located near the processor or co-located with the processor, and larger amounts of slower memory may be located at increasing distances from the processor. For example, processor caches may be faster and located closer to a processor than main system memory, which in turn may be faster and located closer to a processor than on-device persistent storage (e.g., a solid state drive), which in turn may be faster and located closer to a processor than off-device persistent storage (e.g., removable media, networked drives, etc.). Data that is currently being used by a processor may be stored in one or more registers or in a cache associated with (e.g., co-located on a same package) the processor, while data that may have previously been used by the processor or will be used by the processor in the future may be stored in system memory or persistent storage.

Generally, caches may be relatively small memory devices implemented as static random access memory (SRAM) or other high performance memory (e.g., high bandwidth memory (HBM), etc.) which may provide rapid read and write speeds. In contrast, persistent memory, which may be located further away from the processor than caches, may be implemented as nonvolatile random access memory (NVRAM), such as resistive random access memory (RRAM), magnetoresistive random access memory (MRAM), or other memory devices that may provide for less rapid read and write speeds than SRAM or other high performance memory, but may provide higher capacity at lower cost. Still further, dynamic random access memory (DRAM) also provide high capacity at low cost, but may provide for less rapid read and write speeds than SRAM or NVRAM while consuming additional power due to memory refresh operations needed to retain data in memory. In some cases, different types of memory may be fabricated on different process nodes. Generally, higher performance memory may be fabricated on the process nodes used to fabricate the processors on which this higher performance memory is implemented for use as a cache, while lower performance memory may be fabricated on older, larger process nodes. For example, while higher performance memory may be fabricated on a current process node such as 7 nm, lower performance memory may be fabricated on a process node such as 14 nm, 22 nm, or even larger process nodes (e.g., nodes which are at least two generations older (larger) than the current process node).

Machine learning models, such as convolutional neural networks, recurrent neural networks, and the like can be used for various tasks. For example, neural networks may be used for spatial scaling to use artificial intelligence techniques in adjusting the resolution of an image (e.g., using super resolution techniques to increase the resolution of an input image), for temporal interpolation to allow for frames to be generated at higher frame rates (e.g., corresponding to the refresh rate of a display on which the frames are to be displayed), in adjusting the appearance of an image (e.g., through image fusion, applying various color effects, such as generating high dynamic range (HDR) imagery, introducing background or foreground blur (also known as “bokeh”), etc.).

Generally, operations using machine learning models may include multiplication and/or accumulation operations involving weights defined for the machine learning model and input data, which may be retrieved for processing from an external data source or from other portions of a machine learning model. A large amount of data may be used in performing operations using machine learning models, and it may be impractical or impossible to store the data used in a machine learning operation in higher performance memory devices. Thus, data may be swapped from higher performance memory to lower performance memory, and vice versa. The swap process, however, may involve both a power overhead and a performance penalty. For example, a multiply-and-accumulate function may involve some amount of power (e.g., 2.5 pJ) per byte, and a swap operation that moves data from DRAM to SRAM may consume a significant amount of that power (e.g., 90 percent, or 2.25 pJ per byte). Thus, in the context of billions of bytes transferred between DRAM and SRAM during operations of a machine learning model, these swap operations may add processing latency and impose a significant power overhead on a processor. These swap operations may therefore have a negative impact on the battery life of a mobile device on which operations using machine learning models are performed. Further, because a processor in a computing system that implements the von Neumann architecture may not operate on data until such data is loaded into the appropriate memory and because data processing cannot be performed simultaneously with loading data from memory, processing cycles may be wasted in an idle mode until the appropriate data is loaded into memory. The waste of processing cycles while waiting for data to be loaded into the appropriate memory may be referred to as the “von Neumann bottleneck.”

To improve the performance of operations using machine learning models, various techniques may locate computation near or with memory (e.g., co-located with memory). For example, compute-in-memory techniques may allow for data to be stored in SRAM and for analog computation to be performed in memory using modified SRAM cells. In another example, function-in-memory or processing-in-memory techniques may locate digital computation capacity near memory devices (e.g., DRAM, SRAM, MRAM, etc.) in which the weight data and data to be processed are located. In each of these techniques, however, many data transfer operations may still need to be performed to move data into and out of memory for computation (e.g., when computation is co-located with some, but not all, memory in a computing system).

During operations using a machine learning model, such as training of the machine learning model or inference operations using the machine learning model, data to be processed and the results of processing such data may be moved into and out of memory (e.g., a cache, high-performance memory coupled with a processor, memory in a compute-in-memory system, etc.) regularly (e.g., as new inputs are received for processing and the results of processing these inputs are output). However, weight data defining a machine learning model may be repeatedly used during operations using a machine learning model. Because weight data generally remains static during inferencing and during any given training epoch, efficiencies in power consumption, latency, and the like may be gained by persistently, or at least semi-persistently, storing weight data in memory, as such weight data need not be constantly written and re-written during operations using a machine learning model.

Aspects of the present disclosure provide techniques that allow for different types of data to be stored in different memory components associated with a processor to leverage the performance characteristics of these memory components and the static or dynamic nature of the data stored in these memory components. Data that is typically static, such as weight data, may be written once to a first memory component, while data that is more dynamic, such as inputs into a machine learning model and data generated using the machine learning model, may be written to a second memory component coupled with the processor. The second memory component may, for example, provide higher write performance than the first memory component so that the input data can be written to the second memory component and read from the second memory component as needed. By writing weight data or other static data to a first memory component and input data and data generated using the machine learning model to a second memory component, aspects of the present disclosure may reduce the amount of power used during machine learning operations to swap data into and out of memory. These techniques may thus increase power efficiency generally, and particularly battery life on mobile devices on which machine learning operations are performed, reduce memory latencies during machine learning operations, reduce heat generation, and thus generally improve the performance of devices on which machine learning operations performed.

### Example Computing Device Architecture

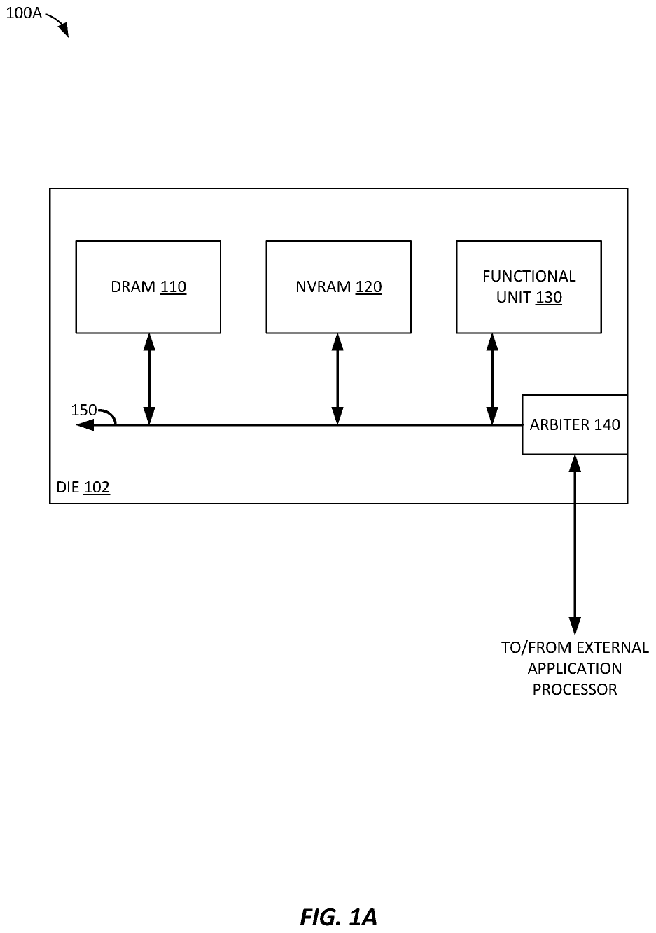

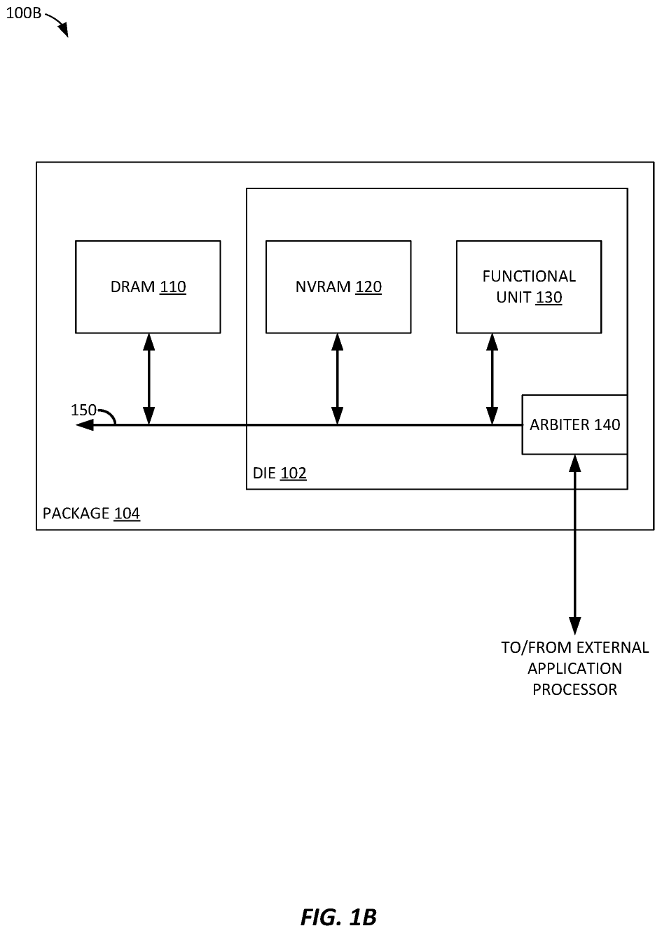

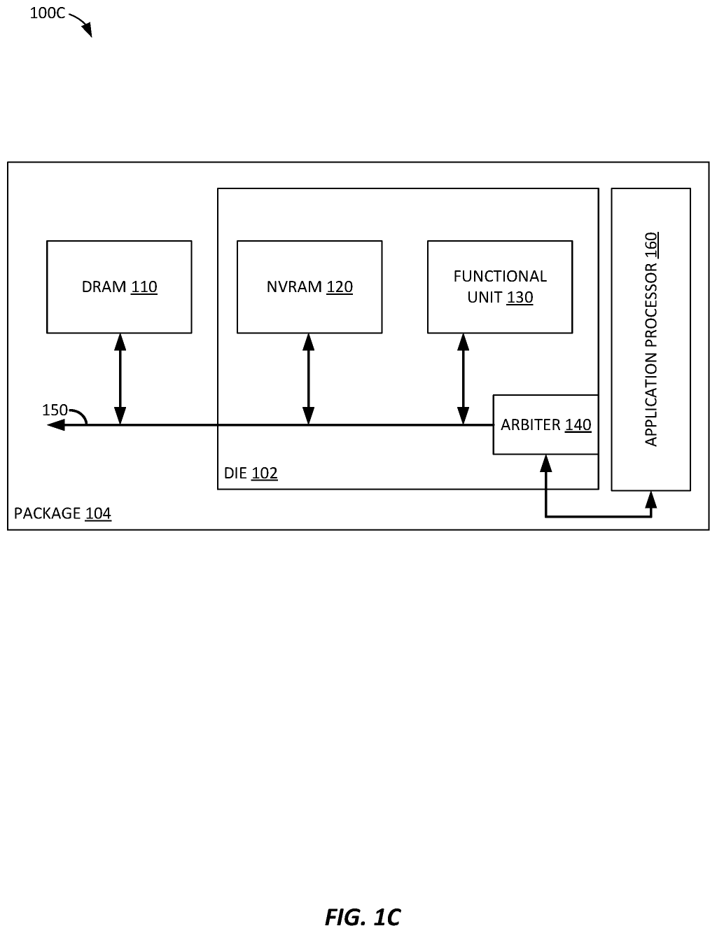

FIGS. 1A-1C illustrate example processing units in which different data relevant for machine learning operations are stored in different types of memory associated with a processor.

Generally, processing units 100A-100C include DRAM 110, NVRAM 120, a functional unit 130, and an arbiter 140, connected via a bus 150. In each of FIGS. 1A-1C, the layout of the DRAM 110, NVRAM 120, functional unit 130, and arbiter 140 is for the purposes of illustration alone. It should be noted that the layout of these components may vary, and these components may be located closer than illustrated in FIGS. 1A-1C.

DRAM 110 generally provides a location in which input data and data generated using a machine learning model may be stored for processing by functional unit 130, while NVRAM 120 provides a location in which weight data for a machine learning model may be stored. Generally, DRAM 110 may provide higher performance than NVRAM 120. For example, latencies in writing data to and/or reading data from DRAM 110 may be lower than latencies in writing data to and reading data from NVRAM 120. Because weight data for a machine learning model may have a high reuse rate during operations using a machine learning model, weight data may be written once and read many times from NVRAM 120. In contrast, because input data and data generated using a machine learning model is written to and read from memory by functional unit 130 many times during operations using the machine learning model, input data and data generated using the machine learning model may be written and read many times from DRAM 110.

During machine learning operations, data used during operations using the machine learning model may be received at arbiter 140 from an application processor, which may be a processor that invokes machine learning operations on processing units 100A-100C. In some aspects, as illustrated in FIGS. 1A and 1B, the application processor may be an external application processor remote from die 102 or a package including die 102. Generally, die 102 may be a monolithic semiconductor substrate (e.g., silicon substrate, silicon-germanium substrate, silicon-on-insulator (Sol) substrate, etc.) on which circuitry is fabricated, while a package may be a carrier in which one or more dies are placed (e.g., for installation into a larger computing system). In some aspects, however, as illustrated in FIG. 1C, the application processor 160 may be located on the same package as die 102.

Generally, arbiter 140 may control where data received from the application processor is written. For example, when machine learning operations are being initiated, arbiter 140 may write weight data defining the machine learning model to NVRAM 120. During machine learning operations, arbiter 140 may write input data received from the application processor (e.g., for processing using the machine learning model and functional unit 130) to DRAM 110. Further, arbiter 140 may output the results of a machine learning model from DRAM 110 to the application processor (e.g., upon receiving a request to read data at a specific address in DRAM 110).

During inference operations using a machine learning model, data may be loaded into registers of functional unit 130 from DRAM 110 and NVRAM 120. To load data into the registers, functional unit 130 can request data located at specified addresses from DRAM 110 and NVRAM 120 via bus 150, and, once received, may write the received data from DRAM 110 and NVRAM 120 to the appropriate registers. Various processing engines in functional unit 130, such as matrix processing engines, neural processing engines, or the like can process the received data from DRAM 110 and NVRAM 120 and generate a result. Functional unit 130 may then write the result to DRAM 110 (e.g., for eventual output to an application processor) and/or retain the result in a memory register for use in subsequent operations using the machine learning model (e.g., when the result is an intermediate result used as an input by a later portion of the machine learning model). In some aspects, such as when NVRAM 120 and functional unit 130 are at least partially co-located, the functional unit can process the data using various process-in-memory techniques.

Generally, during operations using the machine learning model, functional unit 130 may access (read data from and write data to) NVRAM 120 more often than functional unit 130 reads data from DRAM 110. Thus, to manage memory access latency, processing units 100A, 100B, and 100C may be configured such that the NVRAM 120 is positioned closer to functional unit 130 than DRAM 110. Because data located in memory that is closer to a functional unit 130 may be accessed faster than data located further away from functional unit 130 due to the reduced distance over which signaling travels between functional unit 130 and more closely located memory, positioning NVRAM 120 closer to functional unit 130 may reduce read and write latency for input data and data generated by the machine learning model.

FIG. 1A illustrates a processing unit 100A in which DRAM 110, NVRAM 120, functional unit 130, arbiter 140, and bus 150 are fabricated on a single die 102. In processing unit 100A, the DRAM 110, NVRAM 120, functional unit 130, arbiter 140, and bus 150 may be fabricated using a same process node. While processing unit 100A illustrates die 102 laid out linearly, it should be recognized that DRAM 110, NVRAM 120, functional unit 130, arbiter 140, and bus 150 may be laid out in a stacked arrangement, in part or in full. In a stacked arrangement, the functional unit 130 may be positioned at the base of die 102, and DRAM 110 and/or NVRAM 120 may be positioned on top of functional unit 130. Bus 150 may connect, through-vias or other vertical interconnects, DRAM 110 and NVRAM 120 to functional unit 130 and/or arbiter 140, which may reduce the size of die 102.

FIG. 1B illustrates a processing unit 100B in which DRAM 110, NVRAM 120, functional unit 130, arbiter 140, and bus 150 are integrated in a single package. As illustrated, NVRAM 120, functional unit 130, and arbiter 140 may be located on die 102 included in package 104, and DRAM 110 may be a separate unit located on package 104. By integrating DRAM 110 and die 102 as separate components on the same package 104, different fabrication techniques may be used to fabricate DRAM 110 and die 102. For example, die 102 (e.g., NVRAM 120, functional unit 130, and arbiter 140) may be fabricated using a first process node (e.g., a “leading edge” or “current” process node such as 7 nm), while DRAM 110 can be fabricated using a second process node (e.g., on a die fabricated at a node older than a “leading edge” or “current” processing node, such as 14 nm or 22 nm).

FIG. 1C illustrates a processing unit 100C in which DRAM 110, NVRAM 120, functional unit 130, arbiter 140, bus 150, and an application processor 160 are integrated in a single package 104. In this example, DRAM 110, die 102, and application processor 160 may be fabricated separately (e.g., using processing nodes appropriate for the power and performance characteristics of each of DRAM 110, die 102, and application processor 160) and included in the same package. Similarly to processing unit 100B illustrated in FIG. 1B, die 102 may include NVRAM 120, functional unit 130, and arbiter 140. While processing unit 100C illustrates DRAM 110 and die 102 as separate components on the same package 104, it should be recognized that DRAM 110 may be included in die 102 (e.g., as illustrated in FIG. 1A), such that DRAM 110, NVRAM 120, functional unit 130, and arbiter 140 are fabricated on die 102 and application processor 160 is fabricated on a different die.

It should be recognized that FIGS. 1A-1C illustrate various example arrangements of processing units including DRAM 110, NVRAM 120, functional unit 130, arbiter 140, bus 150, and (in some aspects) application processor 160. Various other arrangements of DRAM 110, NVRAM 120, functional unit 130, arbiter 140, bus 150, and/or application processor 160 may also be possible.

### Example Machine Learning Operations Using Weight Data and Input Data in Different Types of Memory

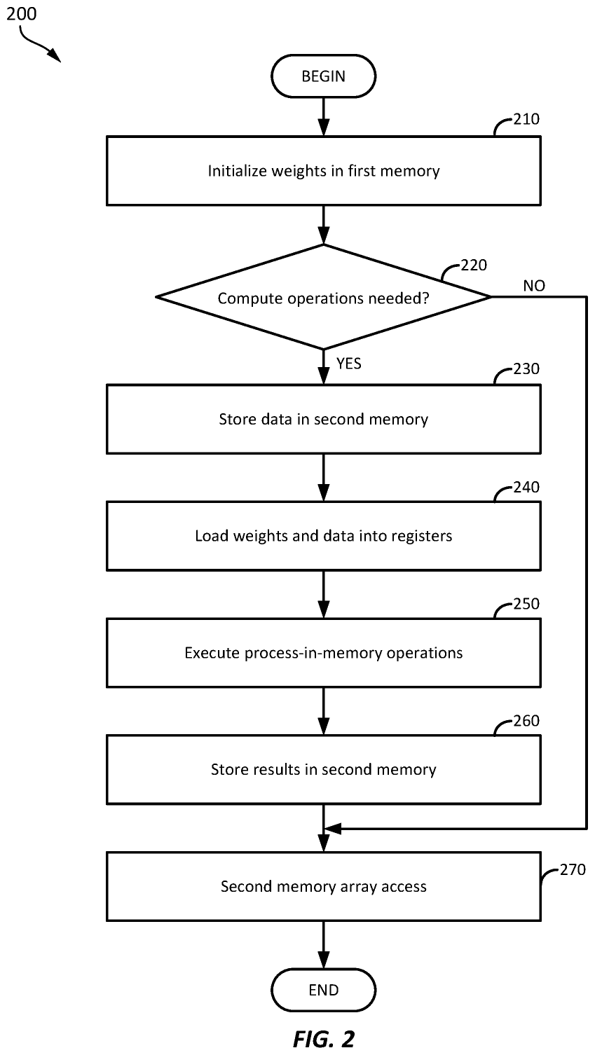

FIG. 2 is a flow chart illustrating operations 200 that may be performed by a processing unit (e.g., processing units 100A illustrated in FIG. 1A, 100B illustrated in FIG. 1B, or 100C illustrated in FIG. 1C) to perform machine learning operations based on data stored in different memory components associated with the processing unit.

As illustrated, operations 200 begin at block 210 with initializing weights for the machine learning model in a first memory. The first memory may be an NVRAM, which may be, for example, MRAM, RRAM, or other nonvolatile memory which may provide high memory density and high access performance, particularly with respect to read operations. As discussed, because the first memory may provide for high-speed data access, and because the weights for a machine learning model may be frequently read during machine learning operations, storing the weights in first memory may allow for low latencies in retrieving the weights for machine learning operations.

At block 220, operations 200 proceed with determining whether compute operations are needed. Generally, compute operations may be needed when a request is received from an application processor for a processing unit 100 to perform inference or training operations on input data an intermediate result of operations using a machine learning model that is pending processing by a later portion of the machine learning model. If no compute operations are needed, operations 200 may proceed to block 270, as discussed in further detail below. For example, it may be determined that compute operations are not needed when a model is pre-loaded into memory prior to machine learning operations being invoked on the processing unit.

Otherwise, if compute operations are needed, operations 200 may proceed from block 220 to block 230, with storing data in a second memory. The second memory may be, for example, a DRAM, or other memory component that has high density (e.g., may be able to store a large amount of data for the amount of physical space that the second memory occupies). Generally, the data stored in the second memory may be input data received from an external application processor, intermediate results of operations using the machine learning model, or other (non-weight) data that may be used during operations using the machine learning model. The second memory may be located near or co-located with a functional unit that executes operations using the weight data stored in the first memory (e.g., an NVRAM) and the data stored in the second memory to reduce the amount of time needed to transfer data from the second memory to the functional unit.

At block 240, operations 200 proceed with loading weights and data into registers associated with the functional unit. The registers associated with the functional unit generally are areas of memory which may be integrated with or otherwise accessible by the functional unit to perform various operations in memory.

In some aspects, the weights and data loaded into the registers may be selected based on the asymmetrical cost of accessing data from NVRAM and accessing data from DRAM (e.g., the difference in computational expense between accessing data from NVRAM and accessing data from DRAM). Generally, because accessing data from NVRAM may be less expensive (e.g., in terms of idle processes wasted while waiting to retrieve data from NVRAM) than accessing data from DRAM, more data may be loaded into the registers from DRAM than from NVRAM.

At block 250, operations 200 proceed with executing operations based on the weights and data loaded into the registers. Generally, the operations may generate a result based on various matrix or tensor operations implemented by the functional unit. In some aspects, the operations may be performed using process-in-memory techniques, such as when a functional unit on which machine learning operations are performed is at least partially co-located with the first memory (e.g., NVRAM) and/or second memory (e.g., DRAM).

At block 260, operations 200 proceed with storing the results of executing the process-in-memory operations at block 250 in the second memory.

At block 270, the results of the process-in-memory operations may be retrieved via regular array access at the second memory. To retrieve the results of the process-in-memory operations, an arbiter (e.g., arbiter 140 illustrated in FIGS. 1A-1C) can receive a request, from another processor, to retrieve data from a specified address in the second memory, which a processor may have previously output to an external source (e.g., an application processor). The arbiter may retrieve the data from the specified address in the second memory and output the retrieved data to the requesting processor.

### Example Methods for Executing Machine Learning Operations Using Weights and Data Stored in Different Types of Memory

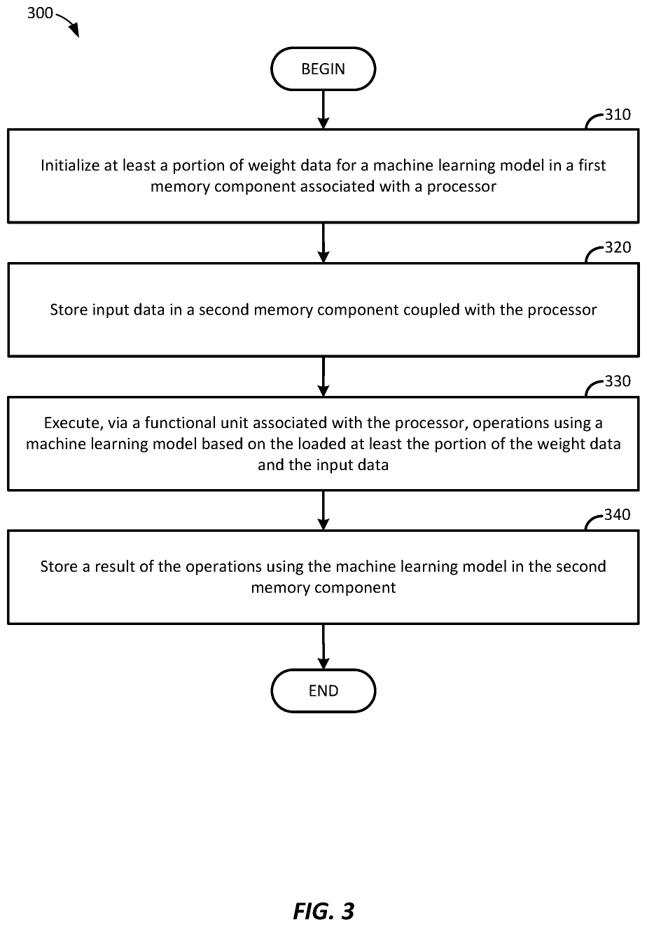

FIG. 3 illustrates example operations 300 that may be performed for executing operations using a machine learning model with different data relevant for the operations being stored in different types of memory associated with a processor, according to aspects of the present disclosure. Operations 300 may be performed, for example, by processors such as processing units 100A-100C illustrated in FIGS. 1A-1C or other processors in which weights and data can be stored in different types of memory for use during operations using a machine learning model. As discussed above, weights, which may remain static during machine learning operations, may be written to a first memory component once and read repeatedly for use throughout the operations using the machine learning model, while data against which machine learning operations are performed may be written to and read from a second memory component repeatedly during operations using the machine learning model.

As illustrated, operations 300 begin at block 310 with initializing at least a portion of weight data for a machine learning model in a first memory component associated with a processor. As discussed, the first memory component may be nonvolatile random access memory, such as MRAM or RRAM, which may provide for high read performance relative to other types of memory.

At block 320, operations 300 proceed with storing input data in a second memory component coupled with the processor. As discussed, the second memory component may be dynamic random access memory. The DRAM may have a sufficient size to store input data for use during operations using the machine learning model.

In some aspects, the input data may include data received from a streaming data source. Generally, a streaming data source may include a data source that generates data continuously for processing using the machine learning model, such as a video camera, an audio capture device, or the like. In some aspects, the input data may include data received from a non-streaming data source, such as a file or a batch of data for processing.

At block 330, operations 300 proceed with executing operations using a machine learning model via a functional unit associated with the processor based on the at least the portion of weight data and the input data.

In some aspects, the operations may be executed using process-in-memory techniques. Generally, in using process-in-memory techniques, memory components and a functional unit of a processor used to execute operations using the machine learning model may be co-located such that the operations are performed on data in the memory components directly. Some data used during the operations using the machine learning model, such as intermediate results, need not be swapped between main memory to the processor when operations are executed using process-in-memory techniques. By reducing the amount of data transferred between main memory and a processor, the techniques described herein may mitigate latencies imposed by the “von Neumann bottleneck” in which data transfer and data processing operations cannot be performed simultaneously. In some aspects, the process-in-memory techniques may be performed in one or more static random access memory (SRAM) components of the processor into which data is loaded.

In some aspects, to execute operations using the machine learning model, at least a portion of the weight data may be loaded from the first memory component into memory registers of the processor. The functional unit generates the result of the operations using the machine learning model, the weight data read from the first memory component into the memory registers of the processor, and the input data, and the generated result is stored in the memory registers of the processor.

In some aspects, the input data from the second memory component may also be loaded into the memory registers of the processor. The result of the operation may then be generated by the functional unit using the input data loaded into the memory registers of the processor.

In some aspects, the data stored in the memory registers of the processor may be selected based on the asymmetrical cost of accessing weight data from the first memory component and the input data from the second memory component. For example, because retrieving weight data from the first memory component may be less computationally expensive than retrieving input data from the second memory component (e.g., cause a processor to execute fewer no-ops, or instructions that cause a processor to perform no action during a processing cycle, while waiting for data to be transferred), the processor registers may include a smaller amount of space for weight data from the first memory component than an amount of space reserved for input data from the second memory component. In selecting the data stored in the memory registers of the processor, the selection may be performed to maximize an amount of time during which operations are performed based on the data in the memory registers before retrieving additional data for processing from the second memory component. By maximizing the amount of time during which operations are performed based on the data in the memory registers, aspects of the present disclosure may reduce the amount of time during which the functional component waits for data to be loaded from the second memory component into registers for processing.

In some aspects, the result of the operations may be read from the memory registers of the processor. The result may subsequently be written to the second memory component to make the result available for subsequent operations using the machine learning model or to external application processors that can use the result of the operations using the machine learning model for other tasks.

At block 340, operations 300 proceed with storing a result of the operations using the machine learning model in the second memory component.

In some aspects, the first memory component may be a memory component having lower storage density and lower write throughput than the second memory component.

In some aspects, the first memory component, the second memory component, and the functional unit of the processor may be integrated on a single die. In such a case, the first memory component, the second memory component, and the functional unit of the processor may be fabricated using a same process node.

In some aspects, the first memory component, the second memory component, and the functional unit of the processor may be integrated in a single package. By packaging the first memory component, the second memory component, and the functional unit of the processor on a single package, different process nodes may be used to fabricate the first memory component, the second memory component, and the functional unit of the processor.

In some aspects, the first memory component may be fabricated using a first process node and the second memory component may be fabricated using a second process node. For example, the first memory component may be fabricated using a same process as the functional unit of the processor, and the second memory component may be fabricated using a larger process than that used to fabricate the first memory component. As an illustrative example, the first memory component may be fabricated using a 7 nanometer class fabrication process, while the second memory component may be fabricated using a fabrication process at a larger node size, such as a 10 nanometer class fabrication process, 14 nanometer class fabrication process, or the like.

For example, the first memory component may be implemented on a first die of the single package and may be fabricated using a first process node, and the second memory component and functional unit of the processor may be implemented on a second die of the single package and may be fabricated using a second process node. In some aspects, the single package may also include an application processor. This application processor may invoke the operations using the first memory component, the second memory component, and the functional unit of the processor.

In some aspects, operations 300 may be performed by an arbiter component of a processor. Generally, the arbiter component may arbitrate operations between the first memory component, the second memory component, and the functional unit of the processor. For example, to arbitrate operations, the arbiter component may route data inputs to the appropriate memory components and may initiate the processing of data using the machine learning model based on commands received from an application processor.

### Example Processing System for Executing Machine Learning Operations Using Weights and Data Stored in Different Types of Memory

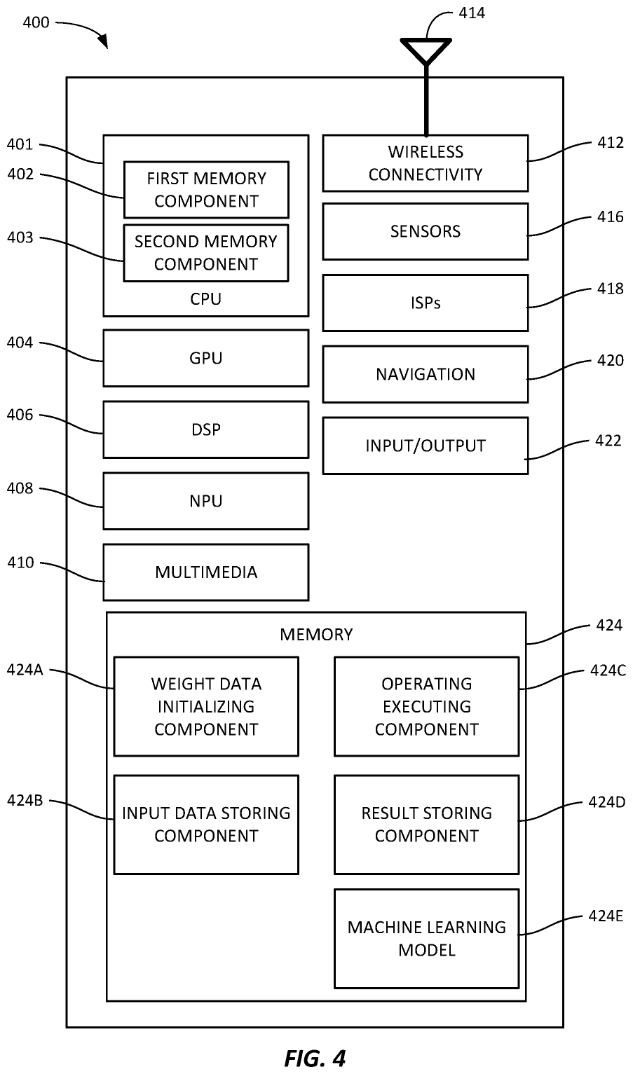

FIG. 4 depicts an example processing system 400 for executing operations using a machine learning model with different data relevant for the operations being stored in different types of memory associated with a processor, such as described herein for example with respect to FIG. 3.

Processing system 400 includes a central processing unit (CPU) 401, which in some examples may be a multi-core CPU. Instructions executed at the CPU 401 may be loaded, for example, from a program memory associated with the CPU 401 or may be loaded from a partition in memory 424. As illustrated, CPU 401 includes a first memory component 402 and a second memory component 403. The first memory component may be memory in which weight data for a machine learning model may be stored, and the second memory component 403 may be memory in which input data processed by the machine learning model may be stored.

Processing system 400 also includes additional processing components tailored to specific functions, such as a graphics processing unit (GPU) 404, a digital signal processor (DSP) 406, a neural processing unit (NPU) 408, a multimedia processing unit 410, a multimedia processing unit 410, and a wireless connectivity component 412.

An NPU, such as NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 408 is a part of one or more of CPU 401, GPU 404, and/or DSP 406.

While not illustrated, it should be recognized that GPU 404, DSP 406, and/or NPU 408 may also include a first memory component in which weight data for a machine learning model may be stored and a second memory component in which input data for a machine learning model may be stored, similar to first memory component 402 and second memory component 403 illustrated with respect to CPU 401 and discussed above.

In some examples, wireless connectivity component 412 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 412 is further connected to one or more antennas 414.

Processing system 400 may also include one or more sensor processing units 416 associated with any manner of sensor, one or more image signal processors (ISPs) 418 associated with any manner of image sensor, and/or a navigation processor 420, which may include satellite-based positioning system components (e.g., GPS or GLONASS) as well as inertial positioning system components.

Processing system 400 may also include one or more input and/or output devices 422, such as screens, touch-sensitive surfaces (including touch-sensitive displays), physical buttons, speakers, microphones, and the like.

In some examples, one or more of the processors of processing system 400 may be based on an ARM or RISC-V instruction set.

Processing system 400 also includes memory 424, which is representative of one or more static and/or dynamic memories, such as a dynamic random access memory, a flash-based static memory, and the like. In this example, memory 424 includes computer-executable components, which may be executed by one or more of the aforementioned processors of processing system 400.

In particular, in this example, memory 424 includes weight data initializing component 424A, input data storing component 424B, operation executing component 424C, result storing component 424D, and machine learning model component 424E. The depicted components, and others not depicted, may be configured to perform various aspects of the methods described herein. The weight data initializing component 424A, input data storing component 424B, operation executing component 424C, and result storing component 424D may correspond to means for performing various operations described herein, including means for initializing at least a portion of weight data, means for storing input data, means for executing operations using a machine learning model, and means for storing results of the operations using the machine learning model, respectively.

Generally, processing system 400 and/or components thereof may be configured to perform the methods described herein.

Notably, in other embodiments, aspects of processing system 400 may be omitted, such as where processing system 400 is a server computer or the like. For example, multimedia processing unit 410, wireless connectivity component 412, sensor processing units 416, ISPs 418, and/or navigation processor 420 may be omitted in other embodiments. Further, aspects of processing system 400 may be distributed, such as training a model and using the model to generate inferences, such as user verification predictions.

### Example Clauses

Implementation examples are described in the following numbered clauses:

Clause 1: A computer-implemented method, comprising: initializing at least a portion of weight data for a machine learning model in a first memory component associated with a processor; storing input data in a second memory component coupled with the processor; executing, via a functional unit associated with the processor, operations using a machine learning model based on the at least the portion of weight data and the input data; and storing a result of the operations using the machine learning model in the second memory component.

Clause 2: The method of Clause 1, wherein executing the operations using the machine learning model comprises: loading at least the portion of the weight data from the first memory component into memory registers of the processor; generating, by the functional unit, the result of the operations using the machine learning model and the input data; and storing the generated result in the memory registers of the processor.

Clause 3: The method of Clause 2, further comprising loading the input data from the second memory component into the memory registers of the processor, wherein the result of the operation is generated by the functional unit using the input data loaded into the memory registers of the processor.

Clause 4: The method of Clause 2 or 3, further comprising: reading the result of the operations from the memory registers of the processor; and writing the result of the operations read from the memory registers of the processor to the second memory component.

Clause 5: The method of Clause 4, wherein data stored in the memory registers of the processor is selected to maximize an amount of time during which operations are performed using data in the memory registers of the processor before retrieving additional data for processing from the second memory component.

Clause 6: The method of Clause 5, wherein the data stored in the memory registers of the processor is further selected based on an asymmetry in access latency between the first memory component and the second memory component.

Clause 7: The method of any of Clauses 1 through 6, wherein the input data comprises data received from a streaming data source.

Clause 8: The method of any of Clauses 1 through 7, wherein the first memory component comprises a memory component with lower storage density and lower write throughput than the second memory component.

Clause 9: The method of Clause 8, wherein the first memory component comprises nonvolatile random access memory (NVRAM) and the second memory component comprises dynamic random access memory (DRAM).

Clause 10: The method of any of Clauses 1 through 9, wherein executing operations using the machine learning model comprises executing the operations using a process-in-memory technique.

Clause 11: The method of Clause 10, wherein the process-in-memory technique comprises performing the operations in one or more static random access memory (SRAM) components of the processor.

Clause 12: The method of any of Clauses 1 through 11, wherein the first memory component, the second memory component, and the functional unit of the processor are integrated on a single die.

Clause 13: The method of any of Clauses 1 through 12, wherein the first memory component, the second memory component, and the functional unit of the processor are integrated in a single package.

Clause 14: The method of Clause 13, wherein the first memory component is implemented in a first die of the single package and wherein the second memory component and the functional unit of the processor are implemented in a second die of the single package.

Clause 15: The method of Clause 13 or 14, wherein the single package further comprises an application processor that invokes the operations using the first memory component, the second memory component, and the functional unit of the processor.

Clause 16: The method of any of Clauses 1 through 15, wherein the method is performed by an arbiter unit of the processor configured to arbitrate operations between the first memory component, the second memory component, and the functional unit of the processor.

Clause 17: The method of any of Clauses 1 through 16, wherein the first memory component comprises a component fabricated using a first process node, wherein the second memory component comprises a component fabricated using a second process node, and wherein the first process node and the second process node are different process nodes.

Clause 18: A processing system, comprising: a memory comprising computer-executable instructions and one or more processors configured to execute the computer-executable instructions and cause the processing system to perform a method in accordance with any of Clauses 1 through 17.

Clause 19: A processing system, comprising means for performing a method in accordance with any of Clauses 1 through 17.

Clause 20: A non-transitory computer-readable medium comprising computer-executable instructions that, when executed by one or more processors of a processing system, cause the processing system to perform a method in accordance with any of Clauses 1 through 17.

Clause 21: A computer program product embodied on a computer-readable storage medium comprising code for performing a method in accordance with any of Clauses 1 through 17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
initializing at least a portion of weight data for a machine learning model in a first memory component associated with a processor;
storing input data in a second memory component coupled with the processor;
executing, via a functional unit associated with the processor, operations using the machine learning model based on the at least the portion of the weight data and the input data; and
storing a result of the operations using the machine learning model in the second memory component.

2. The method of claim 1, wherein executing the operations using the machine learning model comprises:
loading at least the portion of the weight data from the first memory component into memory registers of the processor;
generating, by the functional unit, the result of the operations using the machine learning model and the input data; and
storing the generated result in the memory registers of the processor.

3. The method of claim 2, further comprising loading the input data from the second memory component into the memory registers of the processor, wherein the result of the operations is generated by the functional unit using the input data loaded into the memory registers of the processor.

4. The method of claim 2, further comprising:
reading the result of the operations from the memory registers of the processor; and
writing the result of the operations read from the memory registers of the processor to the second memory component.

5. The method of claim 4, wherein data stored in the memory registers of the processor is selected to maximize an amount of time during which operations are performed using data in the memory registers of the processor before retrieving additional data for processing from the second memory component.

6. The method of claim 5, wherein the data stored in the memory registers of the processor is further selected based on an asymmetry in access latency between the first memory component and the second memory component.

7. The method of claim 1, wherein the input data comprises data received from a streaming data source.

8. The method of claim 1, wherein the first memory component comprises a memory component with lower storage density and lower write throughput than the second memory component.

9. The method of claim 8, wherein the first memory component comprises nonvolatile random access memory (NVRAM) and wherein the second memory component comprises dynamic random access memory (DRAM).

10. The method of claim 1, wherein executing operations using the machine learning model comprises executing the operations using a process-in-memory technique.

11. The method of claim 10, wherein the process-in-memory technique comprises performing the operations in one or more static random access memory (SRAM) components of the processor.

12. The method of claim 1, wherein the first memory component, the second memory component, and the functional unit of the processor are integrated on a single die.

13. The method of claim 1, wherein the first memory component, the second memory component, and the functional unit of the processor are integrated in a single package.

14. The method of claim 13, wherein the first memory component is implemented in a first die of the single package and wherein the second memory component and the functional unit of the processor are implemented in a second die of the single package.

15. The method of claim 13, wherein the single package further comprises an application processor that invokes the operations using the first memory component, the second memory component, and the functional unit of the processor.

16. The method of claim 1, wherein the method is performed by an arbiter unit of the processor configured to arbitrate operations between the first memory component, the second memory component, and the functional unit of the processor.

17. An apparatus, comprising:
a memory having executable instructions stored thereon;
a processor;
a first memory component associated with the processor; and
a second memory component coupled with the processor, wherein the processor is configured to execute the executable instructions to cause the apparatus to:
initialize at least a portion of weight data for a machine learning model in the first memory component associated with the processor;
store input data in the second memory component coupled with the processor;
execute, via a functional unit associated with the processor, operations using the machine learning model based on the at least the portion of the weight data and the input data; and
store a result of the operations using the machine learning model in the second memory component.

18. The apparatus of claim 17, wherein in order to execute the operations using the machine learning model, the processor is configured to cause the apparatus to:
load at least the portion of the weight data from the first memory component into memory registers of the processor;
generate, by the functional unit, the result of the operations using the machine learning model and the input data; and
store the generated result in the memory registers of the processor.

19. The apparatus of claim 18, wherein the processor is further configured to cause the apparatus to load the input data from the second memory component into the memory registers of the processor, wherein the functional unit is configured to generate the result of the operations using the input data loaded into the memory registers of the processor.

20. The apparatus of claim 18, wherein the processor is further configured to:
read the result of the operations from the memory registers of the processor; and
write the result of the operations read from the memory registers of the processor to the second memory component.

21. The apparatus of claim 20, wherein data stored in the memory registers of the processor is selected to maximize an amount of time during which operations are performed using data in the memory registers of the processor before retrieving additional data for processing from the second memory component.

22. The apparatus of claim 17, wherein the first memory component comprises a memory component with lower storage density and lower write throughput than the second memory component.

23. The apparatus of claim 17, wherein in order to execute operations using the machine learning model, the processor is configured to execute the operations using a process-in-memory technique.

24. The apparatus of claim 17, wherein the first memory component, the second memory component, and the functional unit of the processor are integrated on a single die.

25. The apparatus of claim 17, wherein the first memory component, the second memory component, and the functional unit of the processor are integrated in a single package.

26. The apparatus of claim 25, wherein the single package further comprises an application processor configured to invoke the operations using the first memory component, the second memory component, and the functional unit of the processor.

27. The apparatus of claim 17, wherein the first memory component comprises a component fabricated using a first process node, wherein the second memory component comprises a component fabricated using a second process node, and wherein the first process node and the second process node are different process nodes.

28. The apparatus of claim 17, wherein the processor comprises an arbiter unit configured to arbitrate operations between the first memory component, the second memory component, and the functional unit of the processor.

29. An apparatus, comprising:
means for initializing at least a portion of weight data for a machine learning model in a first memory component associated with a processor;
means for storing input data in a second memory component coupled with the processor;
means for executing, via a functional unit associated with the processor, operations using the machine learning model based on the at least the portion of the weight data and the input data; and
means for storing a result of the operations using the machine learning model in the second memory component.

30. A non-transitory computer-readable medium comprising computer-executable instructions that, when executed by one or more processors of a processing system, cause the processing system to perform a method comprising:
initializing at least a portion of weight data for a machine learning model in a first memory component associated with a processor;
storing input data in a second memory component coupled with the processor;
executing, via a functional unit associated with the processor, operations using the machine learning model based on the at least the portion of the weight data and the input data; and
storing a result of the operations using the machine learning model in the second memory component.
